(19) United States
(12) Patent Application Publication
(10) Pub. No.: US 2015/0307685 A1
(43) Pub. Date: Oct. 29, 2015

(54) FLUORORESIN AND SILICA COMPOSITION

(71) Applicant: DUPONT MITSUI FLUOROCHEMICALS CO LTD, WILMINGTON, DE (US)

(72) Inventor: HOAI-NAM PHAM, SHIZUOKA-SHI SHIZUOKA (JP)

(21) Appl. No.: 14/691,865

(22) Filed: Apr. 21, 2015

(30) Foreign Application Priority Data
Apr. 25, 2014 (JP) 2014-091306

(51) Int. Cl. C08K 3/36; B32B 15/08; C09D 127/18; C09J 127/18; B32B 37/14; C10M 111/04

(52) U.S. Cl. CPC C08K 3/36; B32B 37/144; C10M 111/04; C09D 127/18; C09J 127/18; B32B 15/08; B32B 2311/00; B32B 2323/00; B32B 2307/304; B32B 2307/206; B32B 2264/102

(57) ABSTRACT

Provide are fluororesin and silica compositions having a low coefficient of thermal expansion. The fluororesin compositions include 20 to 70 wt % of a melt-processible fluororesin and 80 to 30 wt % of silica particles. The silica particles are constituted by leafy silica secondary particles formed as a result of a parallel overlap of a plurality of scaly silica primary particles, or flower petal-shaped tertiary particles formed as a result of the aggregation of the leafy silica secondary particles, or mixtures thereof. The thickness of the scaly silica primary particle is 0.001 to 0.1 μm, the thickness of the leafy silica secondary particles is 0.001 to 3 μm, and the ratio of the length of the leafy silica secondary particle with respect to their thickness is 2 to 300.

### FIELD OF THE DISCLOSURE

The present disclosure is directed to a fluororesin and silica composition having a low coefficient of thermal expansion.

### BACKGROUND OF DISCLOSURE

Fluororesins, particularly perfluoro resins wherein all polymer chain hydrogen atoms are substituted with fluorine, have excellent properties such as heat resistance, chemical resistance, high frequency electrical properties, non-stickiness, frame resistance, and the like. As a result, these materials are widely used in applications such as: pipelines for transporting chemical liquids such as acids and alkali, solvents, coating materials; chemical industry manufacturing supplies such as chemical liquid storage containers and tanks; as well as electrical industry supplies such as tubes, rollers, electric wires, material for a printed circuit boards.

When a fluororesin is used as a material for forming a printed circuit board, however, it is necessary to fill the fluororesin with a glass cloth, bulking agent (filler), and the like at a high density because of the fluororesin high coefficient of thermal expansion (CTE). When a fluororesin is used as a material of a printed circuit board, furthermore, cases are reported of using composite materials provided by impregnating, with fluororesin dispersions, and firing heat-resistant fiber fabrics (glass cloth) provided as base materials, for reducing the CTE (for example, as disclosed in US 2007/49146 and JP 4,126,115). When a heat-resistant fiber fabric (glass cloth) is provided as a base material, however, problems such as a decrease in manufacturing productivity and an increase in cost due to process complications and reduced workability due to the presence of the base material ensue.

As an example of material which does not use a heat-resistant fiber fabric (glass cloth) as a base material, US 2015/79343 discloses a fluororesin substrate characterized by the formation, atop a metal conductor, of a dielectric layer composed mainly of a fluororesin and by the inclusion of hollow glass beads within the dielectric layer. However, special processing including pressing at a high pressure and then treating with radiation (crosslinking) is required in order to obtain a low CTE.

Japanese Unexamined Patent Application Publication No. 1994-119810 discloses a composition wherein hollow inorganic microspheres as a first filler and porous inorganic particles as a second filler are mixed with a fluororesin. This case, too, however, requires two different types of fillers. Moreover, the use of PTFE (polytetrafluoroethylene) as a fluororesin is presumed.

### SUMMARY OF THE DISCLOSURE

The present invention relates to a melt-processible fluororesin composition having a low coefficient of thermal expansion (CTE) of utility for a material of construction of a printed circuit board for high frequency signal transmission.

The present invention is a fluororesin composition comprising 20 to 70 wt % of a melt-processible fluororesin and 80 to 30 wt % of silica particles. The silica particles are constituted by leafy silica secondary particles formed as a result of a parallel overlap of a plurality of scaly silica primary particles, or flower petal-shaped tertiary particles formed as a result of the aggregation of the leafy silica secondary particles, or mixtures thereof. The thickness of the scaly silica primary particle is 0.001 to 0.1 μm, the thickness of the leafy silica secondary particles is 0.001 to 3 μm, and the ratio of the length of the leafy silica secondary particle with respect to the thickness thereof (aspect ratio) is 2 to 300. In the present invention, the ratio of the melt-processible fluororesin and silica particles is preferably 30 to 60 wt %: 70 to 40 wt %, and more preferably 35 to 55 wt %: 65 to 45 wt %.

In the present invention, a perfluoro resin is desirable as the melt-processible fluororesin. The present invention also pertains to a sheet provided by molding the fluororesin composition of the present invention. The present invention further pertains to a laminated body provided by laminating the sheet of the present invention on a metal foil. The present invention also pertains to a printed circuit board as well as a sliding member, a seal material, or a coaxial cable coating material each manufactured from the sheet of the present invention.

The present invention provides a melt-processible fluororesin composition having a low coefficient of thermal expansion (CTE). The resin composition of the present invention is particularly suitably for printed circuit boards for high frequency signal transmission, coaxial cable coating materials, and the like. It is also useful as sliding members and sealing materials used within environments having significant temperature fluctuations.

### DETAILED DESCRIPTION

Melt-processible Fluororesin

The fluororesin used in the present invention can be selected adventitiously from among resins known as melt-processible fluororesins. Their examples include copolymers of monomers selected from among tetrafluoroethylene, chlorotrifluoroethylene, hexafluoropropylene, perfluoro(alkyl vinyl ether), vinylidene fluoride, and vinyl fluoride and/or copolymers of these monomers and monomers having double bonds such as ethylene, propylene, butylene, pentene, and hexane, and the like or monomers having triple bonds such as acetylene, propyne, and the like. Concrete examples of melt-processible fluororesins include a tetrafluoroethylene-perfluoro (alkyl vinyl ether) copolymer (PFA), tetrafluoroethylene-hexafluoropropylene copolymers (FEP), tetrafluoroethylene-hexafluoropropylene-perfluoro (alkyl vinyl ether) copolymer, tetrafluororehylene-ethylene copolymer, polyvinylidene fluoride, polychlorotrifluoroethylene, and chlorotrifluoroetnylene-ethylene copolymer.

Among these melt-processible fluororesins, it is especially desirable to use perfluororesins such as PFA, FEP, and a tetrafluoroethylene-hexafluoropropylene-perfluoro (alkyl vinyl ether) copolymer from the perspective of heat resistance and electrical properties (dielectric constant and dielectric loss). When PFA is used, the number of carbon atoms of the alkyl group of perfluoro(alkyl vinyl ether) within the PFA is preferably 1 to 5, and more preferably 1 to 3.

In a case where PFA or FEP is used as the melt-processible fluororesin, the melt flow rate (MFR) thereof is preferably 2 to 100 g/10 min, more preferably 5 to 70 g/10 min, or most preferably 10 to 50 g/10 min.

Silica Particles

The silica particles used in the present invention are constituted by leafy silica secondary particles formed as a result of a parallel overlap of a plurality of scaly silica primary particles, or flower petal-shaped tertiary particles formed as a result of the aggregation of the leafy silica secondary particles, or mixtures thereof. The thickness of the scaly silica primary particles is 0.001 to 0.1 μm, the thickness of the leafy silica secondary particles is 0.001 to 3 μm, and the ratio of the length of the leafy silica secondary particles with respect to the thickness thereof (aspect ratio) is 2 to 300. Such leafy silica secondary particles and flower petal-shaped tertiary particles can be manufactured, for example, by the methods described in US2001/3358.

The leafy silica secondary particles used in the present invention have a particle morphology of a laminate structure comprising leafy silica secondary particles formed as a result of overlaps of a plurality of scaly primary particles in a state where interfaces are being oriented in parallel to one another. The thickness of the scaly primary particles is 0.001 to 0.1 μm. Incidentally, there are no problems so long as said thickness is approximately 0.1 μm or less, and it can be estimated from the thickness and diameter of the leafy silica secondary particles. Such scaly primary particles form one or a plurality of overlapping leafy silica secondary particles in a state where interfaces are being oriented in parallel to one another. The thickness of the secondary particles is 0.001 to 3 μm, preferably 0.005 to 2 μm. The scaly silica is such that the ratio of the maximal length of the leafy secondary particles (leaves) with respect to the thickness thereof (aspect ratio) is at least 10, more preferably at least 30, or most preferably at least 50. The ratio of the minimal length of the leafy secondary particles (leaves) with respect to the thickness thereof is at least 2, more preferably at least 5, or most preferably at least 10. These secondary particles exist independently from one another without being fused. The respective upper limits of the ratios of the maximum length and minimum length of the leafy secondary particles with respect to the thickness thereof are not particularly stipulated, although it is practical for the former to be 300 or less, and preferably 200 or less, and for the latter to be 150 or less, and preferably 100 or less.

As described above, the thickness and the length of the leafy secondary particles used in the present invention means the respective average values of said secondary particles unless otherwise specified. It suffices for the scaly shape of the particle to be a thin virtually tabular shape, and it is permissible for the same to be partially or entirely bent or twisted. The leafy silica secondary particles are obtained by disintegrating tertiary aggregate particles (tertiary particles) of silica, and the silica tertiary aggregate particles provided as precursor particles thereof can, to begin with, be manufactured by the following methods.

The first of such methods may, for example, be a method for industrially producing silica tertiary aggregate particles such as silica-X, or the like with good stability within a shorter period of time by hydrothermally treating, as a starting raw ingredient, a silica sol including specified quantities of a silica source and an alkali source, namely an aqueous dispersion of colloidal silica (such as disclosed by Japanese Unexamined Patent Application Publication No. H11-29317). According to this method, aggregates that are tertiary particles having gaps formed as a result of irregular three-dimensional overlaps of the leafy silica secondary particles are obtained as they are. The second method, on the other hand, is a method wherein a silica hydrogel is hydrothermally treated, as a starting material, in the presence of an alkali metal salt, and silica-X, silica-Y, and the like can be manufactured as silica tertiary aggregate particles of the present invention in a high yield via a brief reaction requiring a lower temperature without generating crystals such as quartz, or the like (such as disclosed in Japanese Unexamined Patent Application Publication No. 2000-72432).

When particles abiding in a state where a cake of the hydrothermally treated product obtained by the first method for hydrothermally treating a silica sol or by the second method for hydrothermally treating a silica hydrogel as described above has been filtered and washed with water are observed by using a scanning electron microscope (SEM), it can be identified that silica aggregate particles have been formed as tertiary particles having gaps formed as a result of irregular three-dimensional overlaps of individual leafy secondary particles.

Leafy silica secondary particles can be provided by disintegrating, via various means, the silica tertiary aggregate particles thus manufactured provisionally. As leafy silica secondary particles, the leaf-like secondary particles can be obtained first as an aqueous slurry. A secondary particle slurry can, for example, be provided by disintegrating the silica tertiary aggregate particles of the aqueous slurry form. When the leafy silica secondary particles are observed through a transmission electron microscope at this time, they can be confirmed to be leafy secondary particles for which a plurality of ultrathin scaly primary particles and primary particles are overlapped, oriented in parallel within interfacial gaps. A slurry of the leafy silica secondary particles can also be obtained by manufacturing a dry powder consisting of silica tertiary aggregate particles and then wet-pulverizing (disintegrating) the same. A secondary particle slurry is obtained above, although it is also possible to obtain the same as dry particles.

Moreover, the following method may, for example, be used as a method for obtaining a dry fine powder of leafy silica secondary particles. An aqueous slurry of leafy silica secondary particles has, as already described, a peculiar characteristic of the particles being extremely prone to mutual aggregation during a drying operation. Sufficiently dried leafy silica secondary particles having an average diameter of 1 to 10 μm are obtained exclusively by drying the aqueous slurry including leafy silica secondary particles used in the present invention and obtained by using a spray drier as a drying device and then spray-drying the feed slurry while the SiO₂ concentration therein is being adjusted at 1 to 5 wt %, and preferably 1 to 3 wt %. A secondary particle dry powder can thus be obtained from the aqueous slurry of leafy silica secondary particles. As for a dry powder of monodispersed leafy silica secondary particles, furthermore, dried leaf-like silica secondary particles used in the present invention can be obtained from an aqueous slurry of the aforementioned leafy secondary particles by feeding, into a spray dryer, and drying the aqueous slurry therein according to procedures similar to those noted above. Moreover, a fine powder of leafy silica secondary particles can also be provided by manufacturing a dry powder including silica aggregate particles and then wet-pulverizing (disintegrating) the same.

The silica particles used in the present invention may be prepared as described above, or silica particles (for example known by trade name Sunlovely) having similar physical properties sold by AGC Si-Tech Co., Ltd., for example, may instead be used.

The silica particles used in the present invention may also be provided by hydrophobizing the surfaces of leafy silica secondary particles and/or flower petal-shaped silica tertiary particles (such as disclosed in, for example, Japanese Unexamined Patent Application Publication No. 1994-119810). It is especially desirable to use, as silica particles used in the present invention, flower petal-shaped tertiary particles formed as a result of the aggregation of leafy silica secondary particles. When flower petal-shaped tertiary particles formed as a result of the aggregation of leafy silica secondary particles are used, molten fluororesin infiltrates gaps among leafy silica secondary particles constituting the petal shape so as to strengthen and fix the structure on an occasion for melt-molding the fluororesin composition, and the CTE is accordingly be reduced.

Compositional Ratio (Weight Ratio) of Melt-processible Fluororesin and Silica Particles

The fluororesin composition of the present invention is characterized by the inclusion of 20 to 70 wt % of a melt-processible fluororesin and 80 to 30 wt % of silica particles. The ratio of said melt-processible fluororesin and silica particles is preferably 30 to 60 wt %: 70 to 40 wt %, and more preferably 35 to 55 wt %: 65 to 45 wt %. In a case where the ratio of the melt-processible fluororesin is greater than 70 wt % (namely, where the ratio of the silica particles is less than 30 wt %), a desired low thermal expansion coefficient cannot be obtained. A case where the ratio of the melt-processible fluororesin is less than 20 wt % (namely, where the ratio of the silica particles is greater than 80 wt %) is furthermore undesirable since the moldability and workability of the fluororesin composition are exacerbated and since the strength of the obtained molding is not sufficient.

In a case where the resin composition is used as an insulating material for a printed circuit board, it is desirable to use a resin composition having a thermal expansion coefficient close to the thermal expansion coefficient of copper used as a signal circuit (17 ppm). From this standpoint, the composition of the resin composition of the present invention is preferably selected so as to yield a molding having a coefficient of thermal expansion confined to a range of 10 and 85 ppm, more preferably selected so as to realize a value confined to a range of 10 to 50 ppm, and most preferably selected so as to realize a value confined to a range of 10 to 30 ppm.

Optional Additives

Apart from the melt-processible fluororesin and silica particles, it is permissible to blend, with the fluororesin composition of the present invention, various fillers such as inorganic powders, glass fibers, carbon fibers, metal oxides, carbon, and the like within a range not impairing performances thereof. Apart from fillers, furthermore, it is permissible to blend, with the fluororesin composition of the present invention, pigments, UV absorbers, light stabilizers, antioxidants, antistatic agents, and optional additives according to other applications.

Manufacturing Method of Fluororesin Composition of the Present Invention

The fluororesin composition of the present invention can be manufactured by mixing a melt-processible fluororesin and silica particles constituting this composition by known methods. When the fluororesin composition is prepared, it suffices to charge, into a container, the aforementioned respective components all at once or in multiple batches little-by-little and then agitate and mix the resulting mixture. More specifically, for example, a powder mixing method (dry blending) may be used wherein a melt-processible fluororesin, silica particles, and optional additives are added and mixed with a powder in a dry state, a wet mixing method wherein water or an organic solvent is mixed as a mixing medium, a method for mixing a fluororesin dispersion in a colloidal state and a filler dispersion and then aggregating the mixture still abiding in a high dispersion state (co-aggregation method), and a melt mixing method.

As a melt mixing method, mechanical kneading at a temperature equal to or higher than the melting point of the melt-processible fluororesin is preferred. Melt mixing can, for example, be carried out by using a high-temperature kneader, screw-type extruder, biaxial extruder, or the like. At this time, the melt-processible fluororesin and filler are preferably mixed in advance by such methods as dry blending, wet mixing, or the like prior to the melt mixing.

Moldings can be manufactured by using the fluororesin composition of the present invention as a molding material based on known methods such as melt compression molding, injection molding, extrusion molding, co-extrusion molding, blow molding, inflation molding, transfer molding, coating and the like.

### EXAMPLES

### Measurements of Physical Properties of Raw Materials

(1) Melting Point (Melting Peak Temperature)

The melting point of the melt-processible fluororesin was measured by using a differential scanning calorimeter (Pyris 1 Model DSC, manufactured by Perkin-Elmer Co). Approximately 10 mg of the sample was metered and placed in a dedicated aluminum pan, crimped by a dedicated crimper, and then stored within the DSC body, and the temperature was elevated from 150° C. to 360° C. at 10° C./min. The melting peak temperature (Tm) was calculated from the melting curve obtained at this time.

(2) Melt Flow Rate (MFR)

The melt flow rate (MFR) of the melt-processible fluororesin was determined in accordance with ASTM D-1238-95. A melt indexer equipped with a corrosion-resistant cylinder, a die, and a piston (manufactured by Toyo Seiki Co., Ltd.) was used to fill 5 g of a sample powder into a cylinder being maintained at 372±1° C., the sample powder was maintained therein for 5 min, after which it was extruded through a die orifice under a load of 5 kg (piston and weight), and the extrusion rate (g/10 min.) at this time was calculated as the MFR.

(3) Coefficient of Thermal Expansion (CTE)

A composition was placed within a specified die (dimensions: diameter of 55 mm; height of 30 mm) by using a compression molding device (Hot Press WFA-37, manufactured by Shinto Metal Industries, cylinder diameter: 152 mm), and after the resin had been melted after having been maintained at 360° C. for 15 min, it was melt-compression-molded at a compression molding device cylinder inner pressure (oil pressure) of 2 MPa (actual die press pressure: 15.3 MPa) until spillage of the resin composition occurred, and then it was cooled for 15 min at room temperature, and as a result, a disc-shaped molding having a diameter of 55 mm and a thickness of 2 mm was obtained; it was subjected, as a specimen, to measurements of coefficients of thermal expansion (X direction, Y direction, and Z direction) by using a thermomechanical analyzer (TMA SS7100, manufactured by SII).

Raw Materials Used

The following raw materials were used in examples of the present invention and in comparative embodiments.

(1) Melt-processible Fluororesin

PFA1: a powder of tetrafluoroethylene/perfluoro(propyl vinyl ether) copolymer obtained by emulsion polymerization: MFR: 40 g/10 min; melting point 304° C.

(2) Silica Particles

Flower petal-shaped silica particles: average particle diameter: 4 μm, product name: Sunlovely (AGC Si-Tech Co., Ltd.) Thickness of the leafy silica secondary particles: 10 to 20 nm; major diameter of secondary particles: 0.5 to 2.0 μm; minor diameter of secondary particles: 0.2 to 1.2 μm. These were measured from a SEM microgram photographed through a scanning electron microscope (SU8000, Hitachi High Technologies, Inc.), and the ratio of the maximum length with respect to the thickness (aspect ratio): 25 to 200 was calculated. Incidentally, thicknesses of scaly silica primary particles were estimated to be less than thicknesses of the secondary particles (10 to 20 nm)

Spherical Silica Particles: average particle diameter: 4.6 μm; product name: FB-5D (Denki Kagaku Kogyo Co., Ltd.).

Sample Preparation Method

### (1)Example 1

A mixed composition was obtained by blending PFA1 (MFR: 40 g/10 min; melting point: 304° C.) as a melt-processible fluororesin and flower petal-shaped silica particles as silica particles (filler) at a 50:50 weight ratio so as to yield a total weight of 30 g and then dry-blended at room temperature for 30 sec by using a coffee mill (BC-1752 J, manufactured by Yamada Electric Ind. Co., Ltd.). Thermal expansion coefficients of this composition were then measured by the aforementioned method. The thermal expansion coefficients along all directions were less than 30 ppm and showed extremely low values.

### (2) Example 2

A molding sample was prepared under condition similar to those in Example 1 except that the ratio of the PFA and the flower petal-shaped silica particles was changed to 40:60, and thermal expansion coefficients (X direction and Z direction) of the obtained sample were measured. Extremely favorable thermal expansion coefficients similar to those in Example 1 were obtained.

### (3) Example 3

A molding sample was prepared under condition similar to those in Example 1 except that the ratio of the PFA and the flower petal-shaped silica particles was changed to 60:40, and thermal expansion coefficients (X direction and Z direction) of the obtained sample were measured. Losses of thermal expansion coefficients occurred along both X and Z directions, although the loss of the value along the X direction was not as prominent as the loss of the value along the Z direction.

### (4) Comparative Example 1

A molding sample was prepared under conditions similar to those in Example 1 except that the ratio of the PFA and the petal-like silica particles was changed to 75:25, and the thermal expansion coefficients (X direction and Z direction) of the obtained sample were measured. Thermal expansion coefficients along both X and Z directions showed an extremely high value of 120 ppm.

### (5) Comparative Example 2

A molding sample was prepared by using the PFA alone without adding the flower petal-shaped silica particles under conditions otherwise similar to those in Example 1, and the thermal expansion coefficients (X direction and Z direction) of the obtained sample were measured. Thermal expansion coefficients along both directions showed an extremely high value of 120 ppm.

### (6) Comparative Example 3

A molding sample was prepared under condition similar to those in Example 1 except that spherical silica was used instead of the flower petal-shaped silica particles, and the thermal expansion coefficients (X direction and Z direction) of the obtained sample were measured. Thermal expansion coefficients along both directions were approximately 70 to 80 ppm, and the thermal expansion coefficients were lower than their counterparts of Comparative Example 2, in which no silica particles were included.

The results of Examples 1 to 3 and Comparative Examples 1 to 3 are shown in Table 1 below.

TABLE 1
Sample Compositions and Thermal Expansion Coefficient Values

| | Compositions (wt %) | | | | | |
|---|---|---|---|---|---|---|
| | | Flower | | | | |
| | | petal-shaped | Spherical | CTE (ppm) | | |
| | PFA | Silica | Silica | X | Y | Z |
| Example 2 | 40 | 60 | 0 | 27 | — | 32 |
| Example 1 | 50 | 50 | 0 | 24 | 28 | 29 |
| Example 3 | 60 | 40 | 0 | 81 | — | 47 |
| Comparative | 75 | 25 | 0 | 117 | — | 120 |
| Example 1 | | | | | | |
| Comparative | 100 | 0 | 0 | 120 | 20 | 120 |
| Example 2 | | | | | | |
| Comparative | 50 | 0 | 50 | 77 | 66 | 79 |
| Example 3 | | | | | | |

What is claimed is:

1. A fluororesin composition comprising 20 to 70 weight percent of a melt processible fluororesin and 80 to 30 weight percent of silica particles, wherein said silica particles comprise leafy silica secondary particles formed from a plurality of scaly silica primary particles overlapping in parallel, or flower petal-shaped silica tertiary particles formed from aggregates of said leafy silica secondary particles, or mixtures thereof, wherein the thickness of said scaly silica primary particles is 0.001 to 0.1 μm, the thickness of said leafy silica secondary particles is 0.001 to 3 μm, and the ratio of the length of said leafy silica secondary particles with respect to their thickness is 2 to 300.

2. The fluororesin composition according to claim 1 comprising 30 to 60 weight percent of said fluororesin and 70 to 40 weight percent of said silica particles.

3. The fluororesin composition according to claim 1 comprising 35 to 55 weight percent of said fluororesin and 65 to 45 weight percent of said silica particles.

4. The fluororesin composition according to claim 1, wherein said fluororesin is a perfluoro resin.

5. A sheet provided by molding said fluororesin composition of claim 1.

6. A laminated body provided by laminating said sheet according to claim 5 onto a metal foil.

7. A printed circuit board manufactured from said sheet according to claim 5.

8. A sliding member, a seal material, or a coaxial cable coating material manufactured from said sheet according to claim 5.
